(19) United States
(12) Patent Application Publication
(10) Pub. No.: US 2024/0412467 A1
(43) Pub. Date: Dec. 12, 2024

(54) MIXED REALITY OVERLAY MODIFICATION BASED ON PARALLEL DATA

(71) Applicant: INTERNATIONAL BUSINESS MACHINES CORPORATION, ARMONK, NY (US)

(72) Inventors: Zachary A. Silverstein, Georgetown, TX (US); Logan Bailey, Atlanta, GA (US); Su Liu, Austin, TX (US); Jeremy R. Fox, Georgetown, TX (US)

(21) Appl. No.: 18/331,206

(22) Filed: Jun. 8, 2023

(51) Int. Cl. G06T 19/00; G06T 19/20

(52) U.S. Cl. CPC G06T 19/006; G06T 19/20

(57) ABSTRACT

According to one embodiment, a method, computer system, and computer program product for mixed reality is provided. The present invention may include identifying one or more physical visuals in a physical environment; comparing the identified one or more physical visuals in the physical environment to one or more digital visuals in a mixed reality simulated environment; determining one or more object matches between the identified one or more physical visuals in the physical environment and the one or more digital visuals in the mixed reality simulated environment; and removing one or more corresponding digital visuals of the one or more determined object matches from the mixed reality simulated environment.

### BACKGROUND

The present invention relates, generally, to the field of computing, and more particularly to mixed reality.

Mixed reality (MR) is a technology that uses software to overlay virtual information onto a virtual environment to provide a person with an authentic virtual experience. Mixed reality is built on the convergence of virtual reality (VR) and augmented reality (AR), which allows for a web of networked immersive experiences and social in a multiuser persistent platform. Currently, mixed reality can overlay digital information onto a physical environment to create a simulated environment. However, some of the digital information may already be displayed in the physical environment, and thus, is displayed more than once in the simulated environment. Therefore, in order for true optimization of mixed reality, a method and system by which mixed reality can be used to detect duplicate information in a simulated environment and modify the mixed reality overlay to remove the duplicate information, are needed. Thus, an improvement in mixed reality has the potential to benefit the overall user experience by providing a more accurate, immersive, and meaningful experience.

### SUMMARY

According to one embodiment, a method, computer system, and computer program product for mixed reality is provided. The present invention may include identifying one or more physical visuals in a physical environment; comparing the identified one or more physical visuals in the physical environment to one or more digital visuals in a mixed reality simulated environment; determining one or more object matches between the identified one or more physical visuals in the physical environment and the one or more digital visuals in the mixed reality simulated environment; and removing one or more corresponding digital visuals of the one or more determined object matches from the mixed reality simulated environment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a mixed reality overlay modification determination process according to at least one embodiment;

FIG. 4 is a system diagram illustrating an exemplary program environment of an implementation of a mixed reality overlay modification determination process according to at least one embodiment; and

FIG. 5 is an illustration of a modified mixed reality overlay comprising physical visuals and digital visuals in a mixed reality simulated environment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In a mixed reality simulated environment, digital information and digital objects are overlaid onto a physical environment, creating a mixed reality simulated environment (“MR simulated environment”). Based on the present environment that a user is interacting with, some of the digital information and digital objects may already be present in the physical environment, and thus, already represented in the MR simulated environment. When this scenario occurs, the same information and objects may be displayed in both a virtual form and a physical form. Thus, the MR simulated environment displays duplicate information and objects.

Currently, existing methods attempt to create and display virtual objects in a mixed reality environment. For example, current methods may selectively display virtual elements in a mixed reality environment based on analyzing a user's interactions to filter information retrieval and to correlate the virtual visual features in the mixed reality environment. Other current methods attempt to create and display virtual objects in a mixed reality environment in similar ways. However, a large subset of data may be presented in an MR environment, and based on the physical environment a user is interacting with, some of the presented information may already be present in the physical environment, leading to a double display of certain virtual and physical objects. It is important that, in addition to the current methods, a method exists to detect and remove duplicate objects from an MR simulated environment. Thus, an improvement in MR has the potential to benefit the overall user experience by providing a more accurate, immersive, and meaningful experience.

The present invention has the capacity to improve mixed reality by detecting duplicate information in a simulated environment and modifying the mixed reality overlay to remove the duplicate information. Duplicate information may comprise information and objects that are present in an MR simulated environment in both a physical form and a virtual form. The present invention can use machine learning algorithms and Internet of Things (IoT) devices to compare what is shown in the physical world to what is shown in the MR simulated environment. This improvement in mixed reality can be accomplished by implementing a system that identifies physical visuals in a physical environment using an MR device and IoT device(s) and compares the identified physical visuals to digital visuals in the MR simulated environment using a digital twin process. This improvement in mixed reality can further be accomplished by implementing a system that determines if visuals are displayed in both the MR simulated environment and the physical environment, thus, resulting in the visuals being duplicately displayed in the MR overlay, and removes the duplicate visuals from the mixed reality overlay, thus, only displaying the corresponding physical object of the object match in the MR simulated environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to identify one or more physical visuals in a physical environment, compare the identified one or more physical visuals in the physical environment to one or more digital visuals in a mixed reality simulated environment, determine one or more object matches between the identified one or more physical visuals in the physical environment and the one or more digital visuals in the mixed reality simulated environment, and remove one or more corresponding digital visuals of the one or more determined object matches from the mixed reality simulated environment.

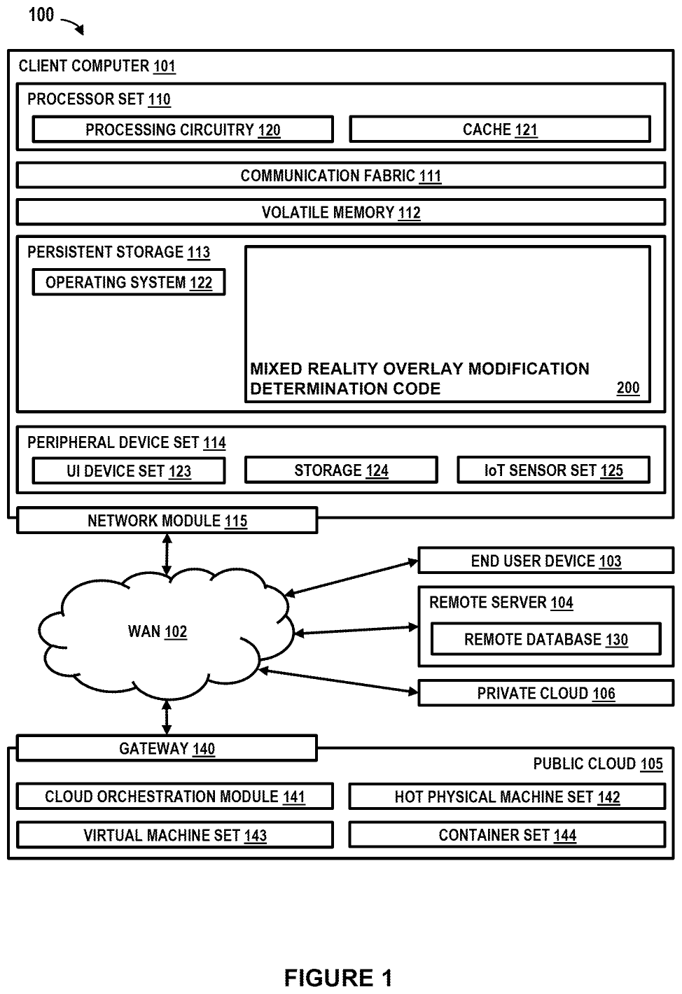

Beginning now with FIG. 1, an exemplary networked computer environment 100 is depicted, according to at least one embodiment. Computing environment 100 contains an example of an environment for the execution of at least some of the computer code involved in performing the inventive methods, such as mixed reality overlay modification determination code 200. In addition to code block 200 computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

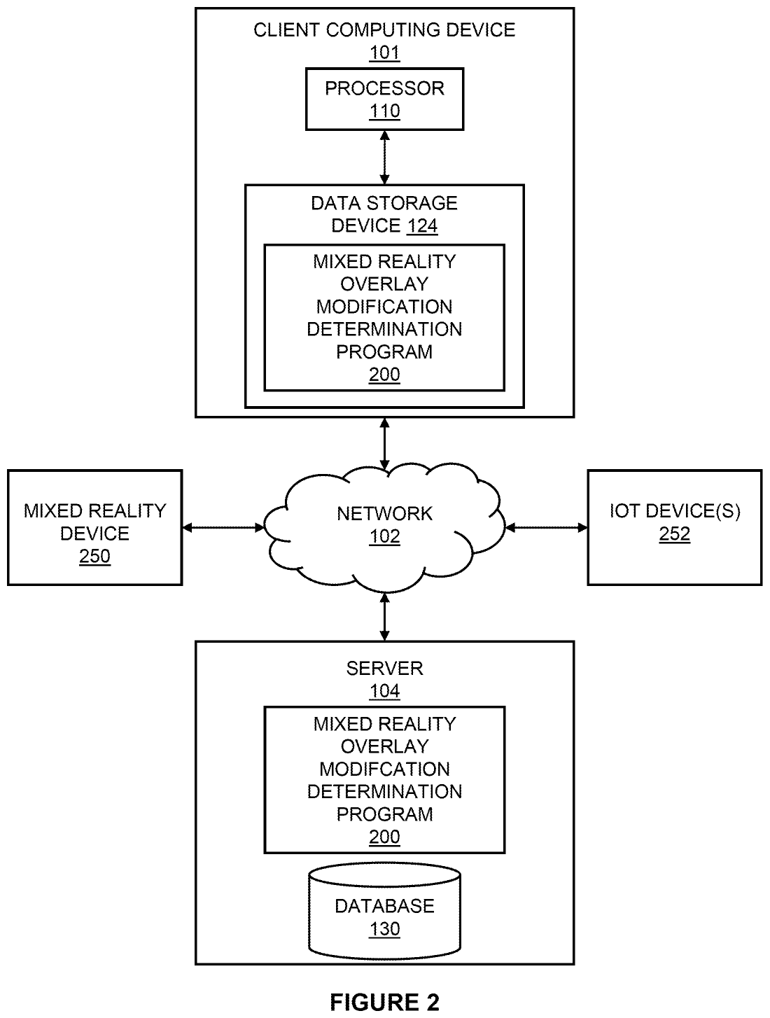

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a mixed reality overlay modification determination program 200 and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a mixed reality overlay modification determination program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can comprise a knowledge corpus. The knowledge corpus may comprise machine learning models and natural language processing algorithms. Additionally, the knowledge corpus can comprise training data used to train the machine learning models and natural language processing algorithms. Also, the knowledge corpus may comprise information relating to object recognition and image recognition. The knowledge corpus may comprise digital twin data. The knowledge corpus may comprise data on digital visuals and mixed reality simulated environments.

Mixed reality (MR) device 250 may be any device or combination of devices, such as a headset, enabled to record world information that the MR module 402 may overlay with computer-generated perceptual elements to create an MR environment. The MR device(s) 250 can record the actions, position, movements, etc. of an MR device 250 wearer, to track the MR device 250 wearer's movement within and interactions with the MR environment. The MR device 250 can display an MR simulated environment to an MR device 250 wearer and allow the MR device 250 wearer to interact with the MR environment. Also, the MR device 250 can comprise a head-mounted display (HMD). Additionally, the MR device 250 may be equipped with or comprise a number of sensors, such as a camera, microphone, and accelerometer, and these sensors may be equipped with or comprise a number of user interface devices such as touchscreens, speakers, etc.

Internet of Things (“IoT”) devices 252 may be any device capable of continuously capturing a physical environment. The IoT device(s) 252 can comprise cameras, such as any device capable of recording visual images in the form of photographs, films, or video signals, such as a physical or virtual camera, and/or sensors, such as accelerometers, gyroscopes, magnetometers, proximity sensors, pressure sensors, etc.

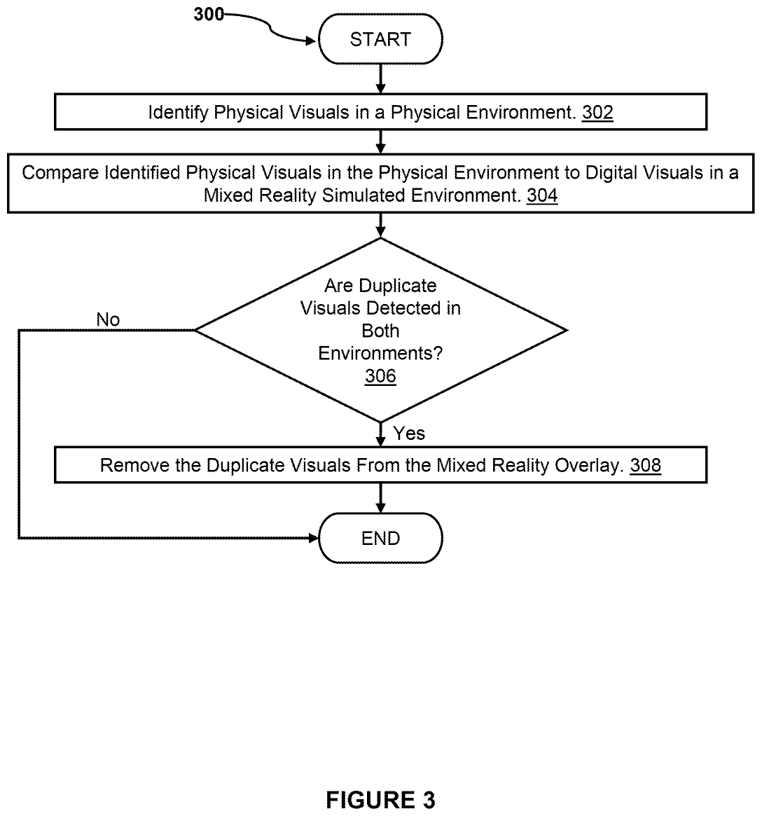

According to the present embodiment, the mixed reality overlay modification determination code 200, “the program”, may be a program capable of identifying physical visuals in a physical environment using an MR device 250 and IoT device(s) 252, comparing the identified physical visuals to digital visuals in the MR simulated environment using a digital twin process, determining if visuals are displayed in both the MR simulated environment and the physical environment, thus, resulting in the visuals being duplicately displayed in the MR overlay, and removing the duplicate visuals from the mixed reality overlay, thus, only displaying the corresponding physical object of the object match in the MR simulated environment. The program 200 may be located on client computing device 101 or remote server 104 or on any other device located within network 102. Furthermore, the program 200 may be distributed in its operation over multiple devices, such as client computing device 101 and remote server 104. The mixed reality overlay modification determination method is explained in further detail below with respect to FIG. 3.

Referring now to FIG. 3, an operational flowchart illustrating a mixed reality overlay modification determination process 300 is depicted according to at least one embodiment. At 302, the program 200 identifies visuals in a physical environment, also referred to as “identified physical visuals” or “physical visuals”, using an MR device 250 and IoT device(s) 252 to capture an MR device 250 wearer's, such as an engineer, real-world physical surroundings, such as a factory floor. Visuals may comprise objects, such as a machine, people, writings, actions, etc. The program 200 can detect and identify visuals in an MR device 250 wearer's real-world physical surroundings using image and object recognition. The program 200 can perform image and object recognition using artificial intelligence systems such as IBM Watson® (IBM Watson® and all IBM Watson®-based trademarks and logos are trademarks or registered trademarks of International Business Machines Corporation, and/or its affiliates). Object recognition may comprise identifying physical objects in image data received from the MR device 250 wearer's real-world physical surroundings. Additionally, object recognition may comprise comparing image data to 3D digital models of physical objects in the database 130 to determine the identification of a physical object within a certain statistical percentage of assurance. Specifically, the program 200 can ingest the captured images from the MR device 250 and the IoT device(s) 252 through machine learning algorithms, such as convolutional neural networks (“CNNs”). The machine learning algorithms can recognize and classify visuals in the physical environment. Additionally, the machine learning algorithms can determine the location of the visuals in the physical environment and other features of the visuals, such as the dimensions, size, shape, and color of the visuals. The program 200 can train the machine learning algorithms using training data. Training data may comprise collected data of visuals in a physical environment and other physical environment data, such as audio signals. Additionally, the program 200 may ingest other captured data, such as audio data, from the MR device 250 and the IoT device (252) through natural language processing (“NLP”) algorithms to understand and interpret the directionality of visuals and other physical environment data. For example, the NLP algorithms can interpret the directionality of audio signals, such as spoken words or machine sounds. The program 200 can train the NLP algorithms using the training data.

At 304, the program 200 compares the identified physical visuals to digital visuals in the MR simulated environment using a digital twin process. A digital twin can be a virtual representation of an object or system and is updated from real-time data and may use simulations to help decision-making. Digital twin processes may be performed using artificial intelligence systems such as Maximo® (Maximo® and all Maximo®-based trademarks and logos are trademarks or registered trademarks of International Business Machines Corporation, and/or its affiliates). The program 200 may import the data and visuals of the digital information and the data of the identified visuals in the physical environment into the digital twin. The digital twin can build a digital replica of the identified physical visuals in a virtual environment. The digital twin process can comprise comparing the location(s) of the physical visuals in the physical environment to the location(s) of the digital visuals in the MR simulated environment. Additionally, the digital twin process may comprise comparing the features of the physical visuals, such as the size, shape, and color of the physical visuals, to the features of digital visuals, to determine whether any physical visual(s) and digital visual(s) are duplicates. The program 200 can determine that the visuals are an object match if there are similarities present between a physical visual and a digital visual, such as location in the MR simulated environment and the visuals comprising similar dimensions, etc. For example, the program 200 may compare identified visuals in a doctor's office to depicted digital visuals in an MR simulated environment of the doctor's office. During the comparison, the program 200 determines that a screen in the doctor's office comprises a graph of a patient's heart rate and that a virtual graph of the patient's heart rate is digitally displayed in the MR simulated environment of the doctor's office. Furthermore, the program 200 determines that both the physical screen in the doctor's office and the virtual graph of the patient's heart rate are located in the same location in the MR simulated environment and that both visuals comprise similar dimensions. Thus, the program 200 determines that the visuals are duplicates. The program 200 may mark the corresponding match(-es) of physical object(s) and digital object(s) as duplicates based on any determined object matches in the comparison process.

Then, at 306, the program 200 determines if visuals are displayed in both the MR simulated environment and the physical environment, thus, resulting in the visuals being duplicately displayed in the MR overlay. According to one implementation, if the program 200 determines that visuals are duplicately displayed in the MR simulated environment (step 306, “YES” branch), the program 200 may continue to step 308 to remove the duplicate visuals from the MR overlay. The program 200 may determine that visuals are duplicately displayed in the MR simulated environment based on if the program 200 marked any corresponding match(-es) of physical object(s) and digital object(s) as duplicates, during step 304. If the program 200 determines that there are no visuals duplicately displayed in the MR simulated environment (step 306, “NO” branch), the program 200 may terminate.

At 308, the program 200 removes the duplicate visuals from the mixed reality overlay, thus, only displaying the corresponding physical object of the object match in the MR simulated environment. Specifically, the program 200 can remove the corresponding digital visual of an object match from the MR overlay by removing the digital visual from the MR simulated environment. Thereafter, the program 200 may no longer display the digital visual in the MR simulated environment. Continuing with the previous example, wherein the program 200 determined that a physical screen in a doctor's office and a virtual graph of the patient's heart rate in an MR simulated environment were duplicates, the program 200 may remove the digitally generated image of the virtual graph of the patient's heart rate in the MR simulated environment of the doctor's office. Thus, the MR simulated environment of the doctor's office may display just the physical screen located in the doctor's office.

In some embodiments of the invention, the program 200 may guide the directionality of the physical visuals in the MR simulated environment. More specifically, the program 200 may direct an MR device 250 wearer on where to look in the MR simulated environment. For example, the program 200 may identify a physical object, for example, a screen, in the MR overlay, such as by displaying an arrow, which had a duplicate digital visual that was removed from the MR overlay. Additionally, for example, the program 200 may identify and direct the MR device 250 wearer's attention to the source of an audio signal, such as machine sounds. The program 200 can capture the directionality of physical visuals using the source physical data.

The program 200 can render a mixed reality (MR) simulated environment. The MR simulated environment may be a hybrid environment comprising both physical and virtual elements. The MR simulated environment may comprise a hybrid physical/virtual world in which one or more MR device 250 wearers may enter, see, move around in, interact with, etc. through the medium of an MR device. The MR device 250 wearers in the MR simulated environment may be able to see and/or interact with the same virtual objects and virtual elements and may interact with virtual representations of each other. The MR simulated environment may comprise MR environments wherein generated images, sounds, haptic feedback, and other sensations are integrated into a real-world environment. Additionally, the MR simulated environment may comprise virtual reality (VR) environments that fully replace the physical environment with virtual elements, such that an MR device 250 wearer experiencing a VR environment cannot see any objects or elements of the physical world; however, the VR environments are anchored to real-world locations, such that the movement of the MR device 250 wearers, virtual objects, virtual environmental effects and elements all occur relative to the corresponding locations in the physical environment.

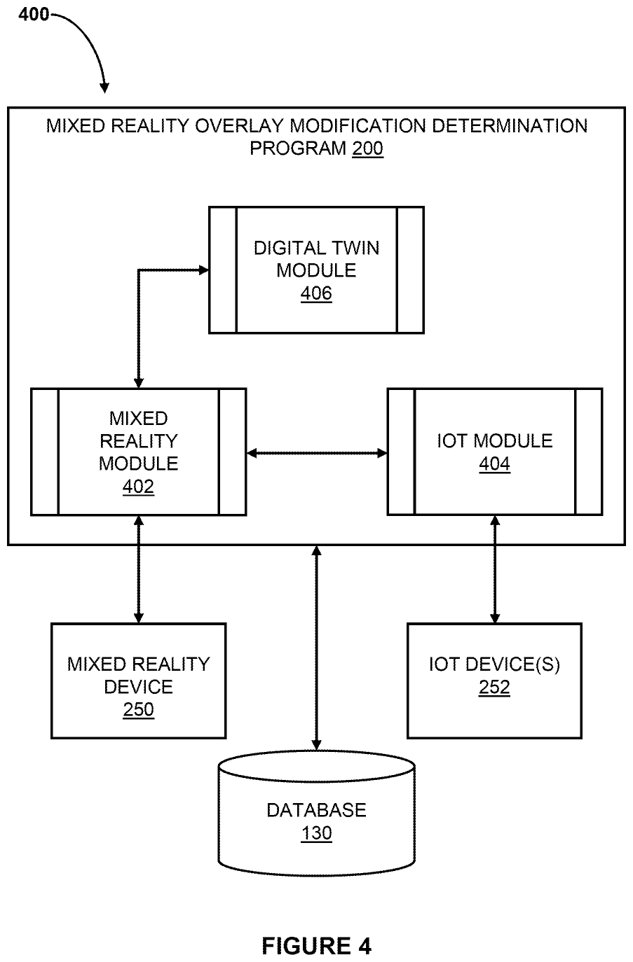

Referring now to FIG. 4, a system diagram illustrating an exemplary program environment 400 of an implementation of a mixed reality overlay modification determination process 300 is depicted according to at least one embodiment. Here, the program 200 comprises a mixed reality module 402, an IoT module 404, and a digital twin module 406. The exemplary program environment 400 details the interactions between the mixed reality module 402 and the IoT module 404, and the mixed reality module 402 and the digital twin module 406. Additionally, the exemplary program environment 400 details the interactions between the MR module 402 and the MR device 250, the IoT module 404 and the IoT device(s) 252, and the mixed reality overlay modification determination program 200 and the database 130.

The MR module 402 may be used to create and display an MR simulated environment and digital objects onto the MR simulated environment. The IoT module 404 may be used to communicate with the IoT device(s) 252. The digital twin module 406 may be used to run a digital twin.

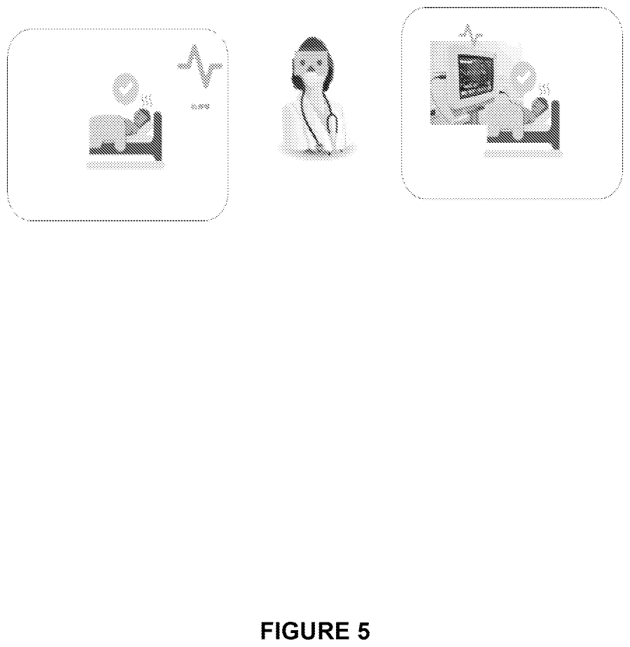

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for mixed reality, the method comprising:
identifying one or more physical visuals in a physical environment;
comparing the identified one or more physical visuals in the physical environment to one or more digital visuals in a mixed reality simulated environment;
determining one or more object matches between the identified one or more physical visuals in the physical environment and the one or more digital visuals in the mixed reality simulated environment; and
removing one or more corresponding digital visuals of the one or more determined object matches from the mixed reality simulated environment.

2. The method of claim 1, wherein the identifying of the one or more physical visuals in the physical environment comprises using one or more Internet of things devices and a mixed reality device.

3. The method of claim 1, wherein the comparing of the identified one or more physical visuals in the physical environment to the one or more digital visuals in the mixed reality simulated environment is performed using a digital twin.

4. The method of claim 1, wherein the identifying of the one or more physical visuals in the physical environment comprises using one or more machine learning models and one or more natural language processing algorithms.

5. The method of claim 1, further comprising:
displaying the mixed reality simulated environment and the one or more digital visuals in the mixed reality simulated environment.

6. The method of claim 1, further comprising:
guiding directionality of the one or more identified physical visuals in the mixed reality simulated environment.

7. The method of claim 1, wherein the determining of the one or more object matches between the identified one or more physical visuals in the physical environment and the one or more digital visuals in the mixed reality simulated environment comprises identifying similarities between locations and dimensions of the one or more identified physical visuals and the one or more digital visuals, in the mixed reality simulated environment.

8. A computer system for mixed reality, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more physical visuals in a physical environment;
comparing the identified one or more physical visuals in the physical environment to one or more digital visuals in a mixed reality simulated environment;
determining one or more object matches between the identified one or more physical visuals in the physical environment and the one or more digital visuals in the mixed reality simulated environment; and
removing one or more corresponding digital visuals of the one or more determined object matches from the mixed reality simulated environment.

9. The computer system of claim 8, wherein the identifying of the one or more physical visuals in the physical environment comprises using one or more Internet of things devices and a mixed reality device.

10. The computer system of claim 8, wherein the comparing of the identified one or more physical visuals in the physical environment to the one or more digital visuals in the mixed reality simulated environment is performed using a digital twin.

11. The computer system of claim 8, wherein the identifying of the one or more physical visuals in the physical environment comprises using one or more machine learning models and one or more natural language processing algorithms.

12. The computer system of claim 8, further comprising:
displaying the mixed reality simulated environment and the one or more digital visuals in the mixed reality simulated environment.

13. The computer system of claim 8, further comprising:
guiding directionality of the one or more identified physical visuals in the mixed reality simulated environment.

14. The computer system of claim 8, wherein the determining of the one or more object matches between the identified one or more physical visuals in the physical environment and the one or more digital visuals in the mixed reality simulated environment comprises identifying similarities between locations and dimensions of the one or more identified physical visuals and the one or more digital visuals, in the mixed reality simulated environment.

15. A computer program product for mixed reality, the computer program product comprising:
one or more computer-readable tangible storage medium and program instructions stored on at least one of the one or more tangible storage medium, the program instructions executable by a processor to cause the processor to perform a method comprising:
identifying one or more physical visuals in a physical environment;
comparing the identified one or more physical visuals in the physical environment to one or more digital visuals in a mixed reality simulated environment;
determining one or more object matches between the identified one or more physical visuals in the physical environment and the one or more digital visuals in the mixed reality simulated environment; and
removing one or more corresponding digital visuals of the one or more determined object matches from the mixed reality simulated environment.

16. The computer program product of claim 15, wherein the identifying of the one or more physical visuals in the physical environment comprises using one or more Internet of things devices and a mixed reality device.

17. The computer program product of claim 15, wherein the comparing of the identified one or more physical visuals in the physical environment to the one or more digital visuals in the mixed reality simulated environment is performed using a digital twin.

18. The computer program product of claim 15, wherein the identifying of the one or more physical visuals in the physical environment comprises using one or more machine learning models and one or more natural language processing algorithms.

19. The computer program product of claim 15, further comprising:
displaying the mixed reality simulated environment and the one or more digital visuals in the mixed reality simulated environment.

20. The computer program product of claim 15, further comprising:
guiding directionality of the one or more identified physical visuals in the mixed reality simulated environment.
